(19) United States
(12) Patent Application Publication
(10) Pub. No.: US 2022/0123471 A1
(43) Pub. Date: Apr. 21, 2022

(54) PATCH RADIATING ELEMENT AND ANTENNA ASSEMBLY

(71) Applicant: CommScope Technologies LLC, Hickory, NC (US)

(72) Inventors: Runmiao Wu, Suzhou (CN); Changfu Chen, Suzhou (CN); Hangsheng Wen, Suzhou (CN); Jian Zhang, Suzhou (CN); Bo Wu, Suzhou (CN); YueMin Li, Suzhou (CN)

(21) Appl. No.: 17/501,377

(22) Filed: Oct. 14, 2021

(30) Foreign Application Priority Data
Oct. 15, 2020 (CN) 202011100797.4
May 7, 2021 (CN) 202110492981.6

(51) Int. Cl. H01Q 9/04; H01Q 21/06

(52) U.S. Cl. CPC H01Q 9/0407; H01Q 21/065

(57) ABSTRACT

A patch radiating element that includes a feeder pillar and a patch radiator mounted on the feeder pillar. The patch radiator includes a first patch portion extending in a first direction and a second patch portion extending from an outer end portion of the first patch portion in a second direction. The second direction is different from the first direction. As a result, a space interval between adjacent patch radiating elements can be increased, thereby improving the isolation between the adjacent patch radiating elements so that beamforming of an antenna can be optimized.

### CROSS-REFERNCE TO RELATED APPLICATIONS

The present application claims the benefit of priority to Chinese Patent Application No. 202011100797.4, filed on Oct. 15, 2020, and to Chinese Patent Application No. 202110492981.6, filed on May 7, 2021, with the entire contents of each above-identified application incorporated by reference as if set forth herein.

### TECHNICAL FIELD

The present disclosure generally relates to radio communications, and more specifically, the present disclosure relates to patch radiating elements and antenna assemblies.

### BACKGROUND

Cellular communications systems are well known in the art. In a cellular communications system, a geographic area is divided into a series of sections that are referred to as “cells” which are served by respective base stations. The base station may include one or more base station antennas that are configured to provide two-way radio frequency (“RF”) communications with mobile subscribers that are within the cell served by the base station.

In many cases, each base station is divided into “sectors.” In perhaps the most common configuration, a hexagonally shaped cell is divided into three 120° sectors, and each sector is served by one or more base station antennas that have an azimuth Half Power Beam Width (HPBW) of approximately 65°. Typically, the base station antennas are mounted on a tower structure, with the radiation patterns that are generated by the base station antennas directed outwardly. Base station antennas are often realized as linear or planar phased arrays of radiating elements.

Patch radiating elements are attracting more and more attention because of their advantages such as low height, light weight, low cost, and high polarization purity. For example, arrays of such patch radiating elements can be used in beamforming antennas or to support massive multi-input-multi-output (MIMO) communications. As the number of patch radiating element arrays mounted on a reflector increases, intervals between patch radiating elements in different arrays are reduced. This leads to stronger coupling interference between the arrays. As a result, the isolation performance of the patch radiating elements deteriorates and the cross-polar discrimination is low, ultimately affecting the beamforming performance of the antenna.

### SUMMARY

Therefore, one of the objectives of the present disclosure is to provide a patch radiating element and an antenna assembly.

According to a first aspect of the present disclosure, a patch radiating element is provided, including: a feeder pillar, which is configured as a PCB feeder pillar; and a patch radiator, which is positioned at a specific position in front of the feeder pillar, wherein a grounded first loop circuit is provided on a first main surface of the feeder pillar, the first loop circuit has a first gap, a first feed circuit coupled to a first RF signal input is provided on a second main surface of the feeder pillar, the first feed circuit crosses the first gap to excite the first loop circuit, thereby feeding the patch radiator, wherein the first loop circuit includes a first opening ring configured to have a rectangular inner circumference and a first stub at at least a first corner of the first opening ring, and an opening of the first opening ring forms the first gap.

According to a second aspect of the present disclosure, a patch radiating element is provided, including: a feeder pillar, which is configured as a PCB feeder pillar; and a patch radiator, which is configured as a rectangular metal sheet and is positioned at a specific position in front of the feeder pillar, wherein a grounded first loop circuit is provided on a first main surface of the feeder pillar, the first loop circuit has a first gap, a first feed circuit coupled to a first RF signal input is provided on a second main surface of the feeder pillar, the first feed circuit crosses the first gap to excite the first loop circuit, thereby feeding the patch radiator, wherein the first main surface of the feeder pillar is further provided with a ground connection portion extending rearward from the first loop circuit, and the ground connection portion has a width smaller than the width of an outer periphery of the first loop circuit.

According to a third aspect of the present disclosure, an antenna assembly is provided, including: a reflector; a first array of first radiating elements arranged on the reflector, the first radiating elements being configured to transmit and receive signals in a first frequency band; and a second array of second radiating elements arranged on the reflector, the second radiating elements being configured to transmit and receive signals in a second frequency band, at least one frequency in the second frequency band being lower than all frequencies in the first frequency band, wherein the first radiating element includes: a feeder pillar, which extends forward from the reflector; and a patch radiator, which is positioned at a specific position in front of the feeder pillar, wherein the feeder pillar is configured as a PCB feeder pillar, a grounded first loop circuit is provided on a first main surface of the feeder pillar, the first loop circuit has a first gap, a first feed circuit coupled to a first RF signal input is provided on a second main surface of the feeder pillar, the first feed circuit crosses the first gap to excite the first loop circuit, so that the first loop circuit feeds the patch radiator in an electromagnetic coupling manner.

According to a fourth aspect of the present disclosure, an antenna assembly is provided, including: a first array of arranged first radiating elements, the first radiating elements being configured to transmit and receive signals in a first frequency band; and a second array of arranged second radiating elements, the second radiating elements being configured to transmit and receive signals in a second frequency band, and the second frequency band is lower than the first frequency band, wherein the first radiating element is the aforementioned patch radiating element.

According to a fifth aspect of the present disclosure, an antenna assembly is provided, including a reflector and a plurality of arrays of the aforementioned patch radiating elements mounted on the reflector.

### BRIEF DESCRIPTION OF THE DRAWINGS

A plurality of aspects of the present disclosure will be better understood after reading the following specific embodiments with reference to the appended drawings. In the appended drawings:

FIG. 1 is a perspective view of a patch radiating element according to some embodiments of the present disclosure;

FIG. 2 is a front view of a patch radiator of the patch radiating element of FIG. 1;

FIG. 3 is a perspective view of a patch radiating element according to some other embodiments of the present disclosure;

FIG. 4a shows a metal pattern on a first main surface of a feeder pillar of the patch radiating element of FIG. 1;

FIG. 4b shows a metal pattern on a second main surface of the feeder pillar of the patch radiating element of FIG. 1;

FIG. 5a is a perspective view of an antenna assembly according to some embodiments of the present disclosure;

FIG. 5b is a front view with an antenna assembly according to some embodiments of the present disclosure.

FIG. 6a is a side view of a patch radiating element according to some embodiments of the present disclosure;

FIG. 6b is a perspective view of the patch radiating element in FIG. 6a, where a patch radiator is removed;

FIG. 7a is a plan view of a first main surface of a feeder pillar of the patch radiating element in FIG. 6a;

FIG. 7b is a plan view of a second main surface of the feeder pillar in FIG. 7a;

FIG. 8a is a top view of an antenna assembly including an array of low-band radiating elements;

FIG. 8b is a radiation pattern of the low-band radiating elements in the antenna assembly shown in FIG. 8a in the azimuth plane;

FIG. 9a is a top view of an antenna assembly according to some embodiments of the present disclosure, wherein the antenna assembly includes an array of low-band radiating elements and an array of high-band radiating elements;

FIG. 9b is a radiation pattern of the low-band radiating elements in the antenna assembly shown in FIG. 9a in the azimuth plane.

### DETAILED DESCRIPTION

The present disclosure will be described below with reference to the appended drawings, and the appended drawings illustrate several embodiments of the present disclosure. However, it should be understood that the present disclosure may be presented in many different ways and is not limited to the embodiments described below; in fact, the embodiments described below are intended to make the disclosure of the present disclosure more complete and to fully explain the protection scope of the present disclosure to those skilled in the art. It should also be understood that the embodiments disclosed in the present disclosure may be combined in various ways so as to provide more additional embodiments.

It should be understood that in all the appended drawings, the same reference numerals and signs denote the same elements. In the appended drawings, the dimensions of certain features can be changed for clarity.

It should be understood that the words in the specification are only used to describe specific embodiments and are not intended to limit the present disclosure. Unless otherwise defined, all terms (including technical terms and scientific terms) used in the specification have the meanings commonly understood by those skilled in the art. For brevity and/or clarity, well-known functions or structures may not be described further in detail.

The singular forms “a,” “an,” “the” and “this” used in the specification all include plural forms unless clearly indicated. The words “include,” “contain” and “have” used in the specification indicate the presence of the claimed features, but do not exclude the presence of one or more other features. The word “and/or” used in the specification includes any or all combinations of one or more of the related listed items. The words “between X and Y” and “between approximate X and Y” used in the specification shall be interpreted as including X and Y. As used herein, the wording “between about X and Y” means “between about X and about Y,” and as used herein, the wording “from about X to Y” means “from about X to about Y.”

In the specification, when an element is referred to as being “on,” “attached” to, “connected” to, “coupled” with, “contacting,” etc., another element, it can be directly on, attached to, connected to, coupled with or contacting another element or an intervening element may also be present. In contrast, if an element is described “directly” “on” another element, “directly attached” to another element, “directly connected” to another element, “directly coupled” to another element or “directly contacting” another element, there will be no intermediate elements. In the specification, a feature that is arranged “adjacent” to another feature, may denote that a feature has a part that overlaps an adjacent feature or a part located above or below the adjacent feature.

In the specification, words expressing spatial relations such as “upper,” “lower,” “left,” “right,” “front,” “rear,” “top,” and “bottom” may describe the relation between one feature and another feature in the appended drawings. It should be understood that, in addition to the orientations shown in the appended drawings, the words expressing spatial relations further include different orientations of a device in use or operation. For example, when a device in the appended drawings rotates reversely, the features originally described as being “below” other features now can be described as being “above” the other features. The device may also be oriented in other directions (rotated by 90 degrees or in other orientations), and in this case, a relative spatial relation will be explained accordingly.

Embodiments of the present disclosure will now be described in more detail with reference to the accompanying drawings.

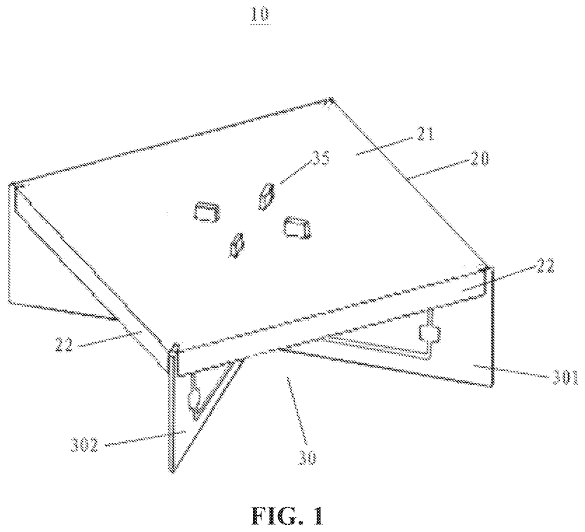

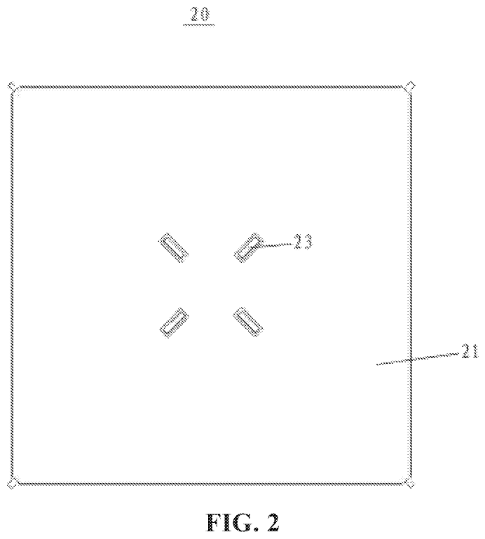

Referring to FIGS. 1 and 2, FIG. 1 is a perspective view of a patch radiating element 10 according to some embodiments of the present disclosure, and FIG. 2 is a front view of a patch radiator 20 of the patch radiating element 10 of FIG. 1.

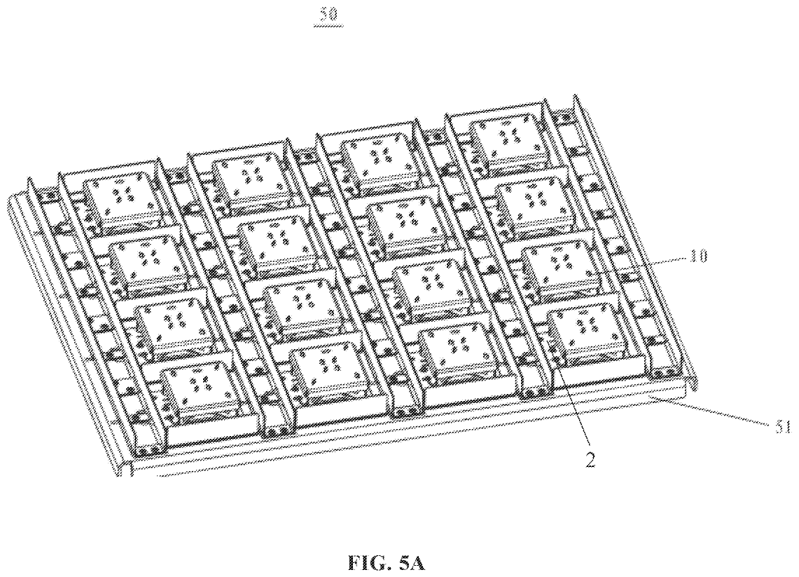

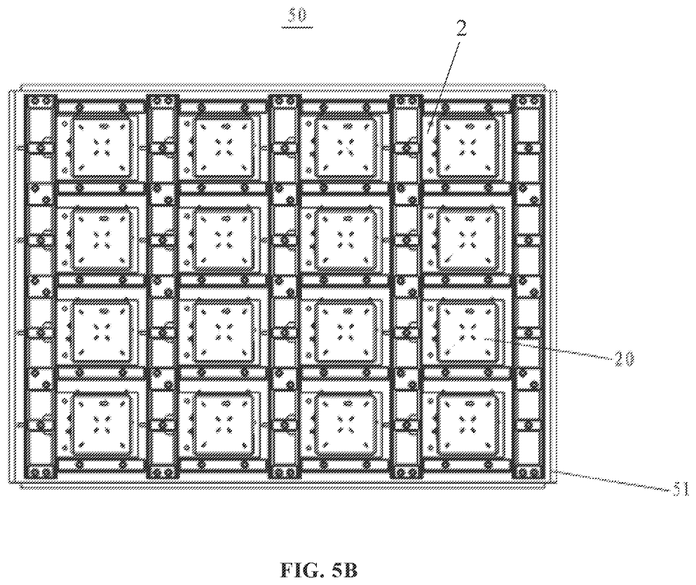

As shown in FIG. 1, the patch radiating element 10 may include a feeder pillar 30 (which also may be referred to as a feed stalk) and the patch radiator 20 mounted on the feeder pillar 30. The feeder pillar 30 may extend forward from a feed board 2 (see FIGS. 5a and 5b) and be mechanically and electrically connected to the patch radiator 20 at a front end portion of the feeder pillar 30 (i.e., the upper end portion in the drawing) so as to feed an RF signal to the patch radiator 20.

In order to meet the requirements on frequency bandwidth and return loss (for example, 15 dB or higher) for modern base station antennas, the patch radiating element 10 may be configured as an air dielectric patch radiating element. The length of the feeder pillar 30 that can extend from the feed board 2 (the length of the feeder pillar 30 extending forward from the feed board 2 may also be described as the distance between the patch radiator 20 and the reflector 51, since the feed board 2 is usually disposed on the front surface of the reflector 51) may be less than 0.2λ, for example, 0.05 to 0.15λ, 0.08 to 0.12λ, or about 0.1λ, wherein, λ is a wavelength corresponding to a center frequency of an operating frequency band of the patch radiating element 10. Therefore, the height of the patch radiating element 10 can be selected to be lower than the height of some conventional radiating elements, which have a feeder pillar height close to 0.25λ. Of course, it is not intended to limit feeder pillars having a higher dimension. In addition, the patch radiating element 10 may be designed as a dual-polarized patch radiating element. As shown in FIG. 1, the patch radiating element 10 may include a first feeder pillar 301 and a second feeder pillar 302 arranged crossing the first feeder pillar 301. The first feeder pillar 301 may be configured to feed an RF signal from a first polarization port to the patch radiator 20, and the second feeder pillar 302 may be configured to feed an RF signal from a second polarization port to the patch radiator 20.

Still referring to FIG. 1, the patch radiator 20 may include a first patch portion 21 extending in a first direction and a second patch portion 22 extending from an outer end portion of the first patch portion 21 in a second direction. In other words, the patch radiator 20 can be transformed from a conventional two-dimensional radiator to a three-dimensional radiator, so that the size of the patch radiator 20 on a two-dimensional plane is reduced while satisfying a certain radiation area. The actual length of each patch radiator 20 is the sum of the length of the first patch portion 21 extending horizontally and the length of the second patch portions 22 extending vertically, for example, respectively located on two sides. As a result, the horizontally extended size of the radiating element is reduced, and thus the interval between adjacent patch radiating elements 10 is increased, thereby improving the isolation between the adjacent patch radiating elements 10. In some embodiments, the upper limit of the ratio of a sum of the areas of the second patch portions 22 to the area of the first patch portion 21 may be 0.5, 0.4, 0.3, 0.2 and 0.1.

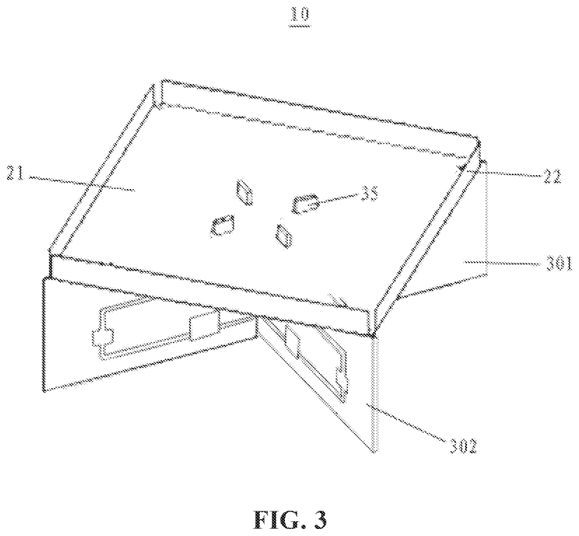

In some embodiments, the second patch portion 22 may extend from the outer end portion of the first patch portion 21 at any angle. For example, the angle between the second patch portion 22 and the first patch portion 21 may be 60° to 120°, or 80° to 100°. In the embodiment of FIG. 1, the second patch portion 22 may be bent toward the feed board 2 while being substantially perpendicular to the first patch portion 21. In other embodiments, the second patch portion 22 may also be bent forward, that is, bent away from the feed board 2. As shown in FIG. 3, the second patch portion 22 may be bent away from the feed board 2 while being substantially perpendicular to the first patch portion 21.

Additionally or optionally, the patch radiator 20 may be a sheet metal radiator. The sheet metal radiators are advantageous in that: firstly, the sheet metal radiators can easily realize bending of metal plates, and thus each second patch portion 22 can be integrally shaped with the first patch portion 21; secondly, the cost of the sheet metal radiators can be lower; thirdly, the sheet metal radiators may be formed to have any desired thickness, and hence may exhibit improved impedance matching and/or reduced signal transmission losses; fourthly, the sheet metal radiators may be readily provided with low levels of surface roughness, which may result in improved passive intermodulation (“PIM”) distortion performance.

Additionally or optionally, the first patch portion 21 may be configured as regular shapes, for example, a polygonal metal sheet, a rectangular metal sheet, or a square metal sheet. In the embodiments of FIGS. 1 and 2, the first patch portion 21 may be configured as a substantially square metal sheet. The square first patch portion 21 is conducive to a balanced current distribution, thereby further improving the polarization purity of a radiation pattern of the patch radiating element 10. In addition, it can be seen from the drawings that each side edge of the first patch portion 21 may be connected with a corresponding second patch portion 22, thereby maintaining the symmetry and balance of the patch radiator 20.

It should be understood that the number, shape, and connection relation of the first patch portion 21 and/or the second patch portion 22 are not limited. In other embodiments, the first patch portion 21 may be configured as a metal sheet with an arc. In other embodiments, it is also possible that a part of the side edges of the first patch portion 21 is connected with the corresponding second patch portion 22.

Additionally or optionally, the second patch portion 22 may be configured as a rectangular metal strip or a metal strip with an arc. In the embodiment of FIG. 1, the second patch portion 22 may be configured as a rectangular metal strip, and each second patch portion 22 extends from a corresponding side edge of the first patch portion 21 in the second direction. Advantageously, each second patch portion 22 may have approximately the same shape, and thus the entire patch radiator 20 can have an approximately symmetrical structure. The symmetrical patch radiator 20 is conducive to formation of a balanced current distribution thereon, thereby further improving the polarization purity of the radiation pattern of the patch radiating element 10.

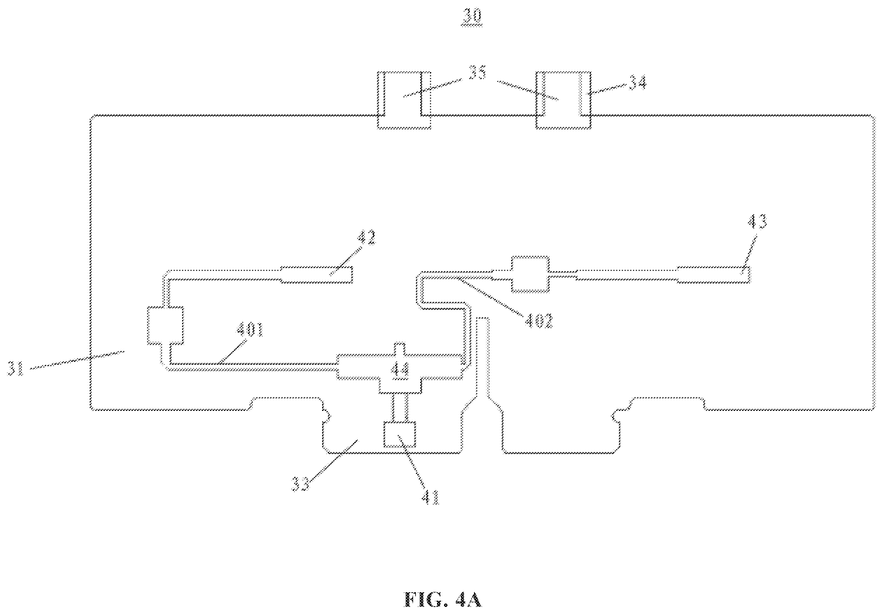

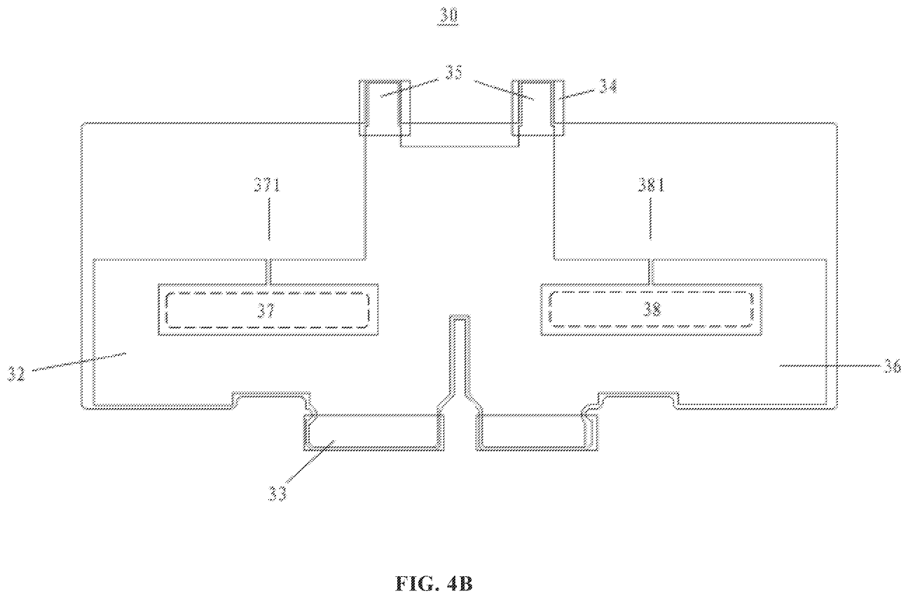

Next, the feeder pillar 30 of the patch radiating element 10 according to some embodiments of the present disclosure will further be described in detail with reference to FIGS. 4a and 4b, wherein, FIG. 4a shows a first metal pattern 31 on a first main surface of the feeder pillar 30 and FIG. 4b shows a second metal pattern 32 on a second main surface of the feeder pillar 30. As shown in FIG. 1, the feeder pillar 30 may be configured as a PCB feeder pillar, which may include a pair of printed circuit boards, that is, a first feeder pillar for an RF signal having a first polarization and a second feeder pillar for an RF signal having a second polarization. The pair of printed circuit boards may cross with each other, for example, oriented at an angle of 90°, so as to have an X-shaped cross section. Each feeder pillar 30 may be mounted on the feed board 2 through one end portion (that is, a lower end portion 33). The patch radiator 20 may be mounted on the opposing other end portion (that is, an upper end portion 34) of each feeder pillar 30. A contact pin 35 may be provided on the upper end portion 34 of each feeder pillar 30, and the contact pin 35 is embedded in a feed port 23 of the first patch portion 21 of the patch radiator 20 to mount the patch radiator 20 on the feeder pillar 30. The first patch portion 21 may include a first feed port and a second feed port for the RF signal having the first polarization, and a third feed port and a fourth feed port for the RF signal having the second polarization. The first feeder pillar 301 may be electrically connected, for example, welded, to the first feed port and the second feed port respectively, and the second feeder pillar 302 may be electrically connected, for example, welded, to the third feed port and the fourth feed port respectively, thereby providing a signal path from the feed board 2 to the corresponding patch radiator 20 via the feeder pillar 30.

As shown in FIG. 4a, the first metal pattern 31, which includes a printed feed circuit, may be printed on the first main surface of the feeder pillar 30. The first metal pattern 31 may include a first feed end 41, which may be provided on the lower end portion 33 of the feeder pillar 30, and the feeder pillar 30 can be mounted on the feed board 2 and be electrically connected to the feed circuit on the feed board 2 through the lower end portion 33. The first metal pattern 31 may further include a power divider 44, a second feed end 42, and a third feed end 43. The power divider 44 may be configured to divide an RF signal from the first feed end 41. Referring to FIG. 4a, the power divider 44 may be configured as a one-to-two power divider 44 to divide the RF signal from the first feed end 41 into in-phase first and second sub-RF signals that have equal amplitudes. The first sub-RF signal can reach the second feed end 42 via a first transmission line 401, and the second sub-RF signal can reach the third feed end 43 via a second transmission line 402. Compared to a conventional L-shaped feeding method, the feeding method based on a dual-feeding branch shown in the present embodiment can achieve a more balanced feeding. The balanced feeding is conducive to the improvement of the shape of the radiation pattern and an increase in the polarization purity.

The second metal pattern 32 is provided on the second main surface opposite to the first main surface of the feeder pillar 30. As shown in FIG. 4b, the second metal pattern 32 may include a grounded metal section 36, which may be electrically connected, for example, welded, to the patch radiator 20 on the upper end portion 34 of the feeder pillar 30 and electrically connected to a ground layer of the feed board 2 on the lower end portion 33 of the feeder pillar 30, thereby forming a return path for the RF signal and realizing effective transmission of the RF signal on the feeder pillar 30 under the interaction with the feed circuit in the first metal pattern 31.

Additionally or optionally, the grounded metal section 36 in the second metal pattern 32 may further include a first inductive circuit loop 37 with a first gap 371 and a second inductive circuit loop 38 with a second gap 381. The first transmission line 401 in the first metal pattern 31 corresponds to the first inductive circuit loop 37, and the second transmission line 402 in the first metal pattern 31 corresponds to the second inductive circuit loop 38. In other words, the first transmission line 401 on the second main surface is within a perimeter of the first inductive circuit loop 37 on the opposite first main surface, and the second transmission line 402 on the second main surface is within a perimeter of the second inductive circuit loop 38 on the opposite first main surface. In addition, the second feed end 42 and the third feed end 43 in the first metal pattern 31 may be respectively configured as an open stub functioning as a capacitor. In this way, a dual LC resonator can be formed on the feeder pillar 30. That is, the first inductive circuit loop 37 and the second feed end 42 function as a first LC resonator, and the second inductive circuit loop 38 and the third feed end 43 function as a second LC resonator. Since the patch radiator 20 can be equivalent to an RLC parallel resonator, the dual LC resonator can provide more flexible and balanced tuning for the patch radiator 20. Since the patch radiator 20 is transformed from a conventional two-dimensional radiator to a three-dimensional radiator, the equivalent capacitance and/or equivalent inductance parameters of the patch radiator 20 itself may change. The dual LC resonator on the feeder pillar 30 can at least partially compensate or balance the LC parameter changes of the patch radiator 20, and thus can maintain good RF performance, for example, return loss, operating bandwidth, or cross-polar discrimination, etc., given that the horizontal size of the patch radiator 20 is reduced.

FIGS. 5a and 5b respectively show a perspective view and a front view of an antenna assembly 50 according to some embodiments of the present disclosure. The antenna assembly 50 may include a reflector 51 and a plurality of radiating element 10 arrays mounted on the reflector 51. The reflector may be used as a ground plane structure of each patch radiating element 10, and each patch radiating element 10 may be mounted to extend forward from the reflector. Since the patch radiator 20 is transformed from a conventional two-dimensional radiator to a three-dimensional radiator, the center-to-center interval between adjacent patch radiating elements 10 can be reduced without degrading the isolation and/or cross-polar discrimination of the patch radiating elements 10.

Additionally or optionally, longitudinal barriers and/or transverse barriers may be provided for the patch radiating elements 10 to further reduce the coupling interference between adjacent patch radiating elements 10, thereby improving the radiation pattern of the antenna.

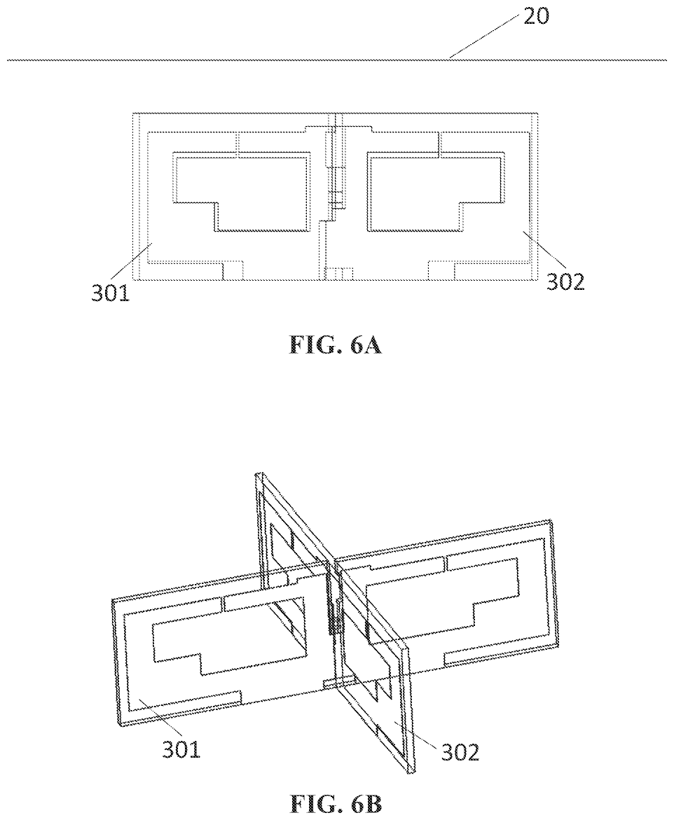

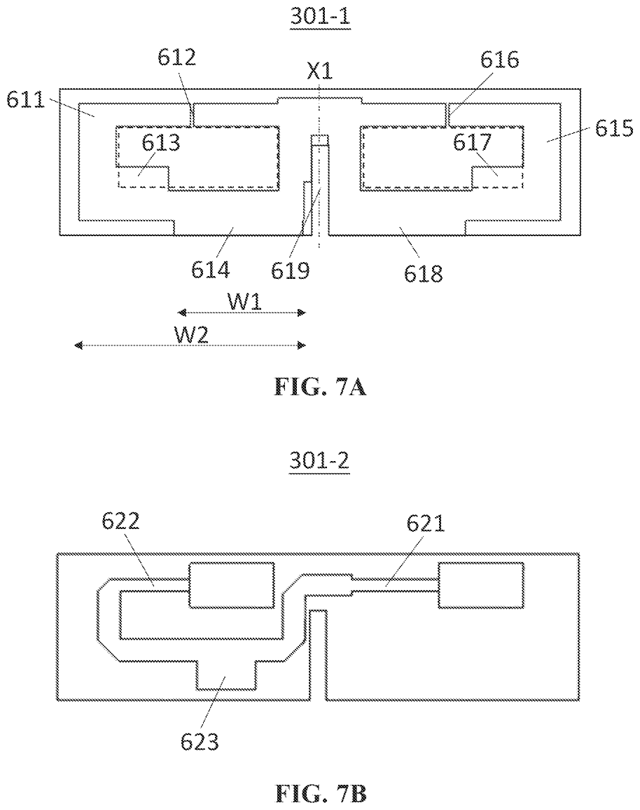

A patch radiating element 10 according to some embodiments of the present disclosure will be described below with reference to FIGS. 6a to 7b. For parts that are the same or similar to those in the aforementioned embodiments, the description thereof will be omitted or only a brief description will be given.

The patch radiating element 10 includes a feeder pillar 301 and a feeder pillar 302, and a patch radiator 20 positioned at a specific position in front of (above, in the view direction of FIG. 6a) the feeder pillars 301 and 302. In the illustrated embodiment, the patch radiator 20 is a two-dimensional planar radiator, for example, configured as a rectangular metal sheet (for example, a square metal sheet). The size of the diagonal line of the patch radiator 20 may be 0.5λ, where λ is the wavelength in a medium corresponding to the center frequency of the operating frequency band of the patch radiating element 10. In the illustrated embodiment, the patch radiating element 10 is configured as an air dielectric patch radiating element, and thus the wavelength in the medium is the wavelength in the air. It should be understood that in other embodiments, the patch radiator 20 may be configured in the shapes shown in FIGS. 1, 3, 5a, and 5b, that is, it may include a first patch portion extending in a first direction and a second patch portion extending from an outer end portion of the first patch portion in a second direction. The feeder pillar 301 and the feeder pillar 302 are both configured as PCBs. The feeder pillar 301 is provided with a mounting portion 619 at a first axis X1 (for example, a central axis) in a front-rear direction (an up-down direction in the view direction of FIG. 7a). The feeder pillar 302 is provided with another mounting portion at a corresponding position (for example, a central axis in the front-rear direction) matching with the mounting portion 619. The feeder pillar 301 and the feeder pillar 302 are mounted substantially perpendicular to each other via the mounting portion 619 and the other mounting portion. The feeder pillar 301 feeds a first RF signal from a first polarization port to the patch radiator 20 in an electromagnetic coupling manner in a first polarization direction (for example, a direction inclined by +45° relative to a longitudinal axis of the antenna assembly), and the feeder pillar 302 feeds a second RF signal from a second polarization port to the patch radiator 20 in an electromagnetic coupling manner in a second polarization direction (for example, a direction inclined by −45° relative to the longitudinal axis of the antenna assembly).

The structure of the feeder pillar 301 will be described below with reference to FIGS. 7a and 7b. A person skilled in the art should understand that the feeder pillar 302 has a structure similar to that of the feeder pillar 301, and thus the description thereof is omitted. As shown in FIG. 7a, a grounded first loop circuit and a grounded second loop circuit are provided on a first main surface 301-1 of the feeder pillar 301. The first loop circuit and the second loop circuit are substantially symmetrical about a first axis X1. The first loop circuit and the second loop circuit form the second metal pattern 32 described above.

The first loop circuit includes an opening ring 611 configured to have a rectangular inner circumference (as shown by the broken lines in the figure). An opening of the opening ring 611 forms a gap 612 of the first loop circuit. In the illustrated embodiment, the gap 612 is located at a front portion (an upper portion in the view direction of FIG. 7a) of the opening ring 611. It should be understood that in other embodiments, the opening of the opening ring (that is, the gap of the loop circuit) may be located at other appropriate positions of the opening ring. The first loop circuit further includes a stub 613 located at the lower left corner of the rectangle of the opening ring 611. The stub 613 is inside the opening ring 611, starting from one side located at the lower left corner and extending along another side adjacent to the side. The second loop circuit includes an opening ring 615 configured to have a rectangular inner circumference with a gap 616, and a stub 617 located at the lower right corner of the rectangle of the opening ring 615. The position, shape, size and other characteristics of the stub 617 are substantially symmetrical to those of the stub 613 about the first axis X1.

Each loop circuit is configured such that its resonance frequency is substantially the same as a resonance frequency of the patch radiator 20, and the resonance frequency of the first loop circuit and the resonance frequency of the second loop circuit are the same in order to feed the patch radiator 20. The resonance frequency of the loop circuit is related to the length of its current path, that is, related to the perimeter of the inner circumference of the opening ring 611 or 615. The stubs 613 and 617 are provided on the inner circumferences of the opening rings 611 and 615, and the impedance of the loop circuits can be changed without changing the perimeter of the inner circumference of the opening ring 611 or 615, that is, without changing the resonance frequencies of the loop circuits. Therefore, the aforementioned method of setting the stubs 613 and 617 can be used to adjust the impedance matching state of the patch radiating element 10. In the illustrated embodiment, the stub is only provided at the lower left corner of the inner circumference of the first loop circuit and the lower right corner of the inner circumference of the second loop circuit. It should be understood that in other embodiments, one or more stubs may be provided at any one or more corners of the rectangular inner circumference of each loop circuit, as long as the position, shape, size and other characteristics of the stubs in the first loop circuit and the second loop circuit are substantially symmetrical about the first axis X1.

Similar to the description above with reference to FIG. 4a, a feed circuit 621 and a feed circuit 622 respectively coupled to the first RF signal (for example, an RF signal from the first polarization port of the antenna) input through an input portion 623 are provided on a second main surface 301-2 of the feeder pillar 301. It can be seen that the input portion 623 and the feed circuits 621 and 622 form the first metal pattern 31 described above. The feed circuit 621 and the feed circuit 622 on the second main surface 301-2 of the PCB cross the gap 612 and the gap 616 on the first main surface 301-1 of the PCB respectively to excite the first and the second loop circuits respectively, so that the first and the second loop circuits feed the patch radiator 20 together.

In the illustrated embodiment, the first loop circuit further includes a ground connection portion 614 extending rearward (downward in the view direction of FIG. 7a) from the outer periphery of a rear end (a lower end in the view direction of FIG. 7a) of the opening ring 611. The second loop circuit further includes a ground connection portion 618 extending rearward from the outer periphery of a rear end of the opening ring 615. The ground connection portions 614 and 618 may be electrically connected to a reflector (the reflector 51 in FIGS. 5a and 5b), thereby grounding the first and the second loop circuits. The width W1 of the ground connection portions 614 and 618 is smaller than the width W2 of the outer periphery of the corresponding opening rings 611 and 615. In some embodiments, the width W1 of the ground connection portions 614 and 618 may be smaller than 2/3 of the width W2 of the outer periphery of the corresponding opening rings 611 and 615, or smaller than ½ of the width W2 of the outer periphery of the corresponding opening rings 611 and 615.

The width W1 of the ground connection portions 614 and 618 being smaller than the width W2 of the outer periphery of the corresponding opening rings 611 and 615 reduces the size of a portion used to connect the feeder pillars 301 and 302 with a feed board (for example, the feed board 2 in FIGS. 5a and 5b). This is conducive to the arrangement of transmission lines on the feed board. When the width W1 of the ground connection portions 614 and 618 is merely slightly smaller (for example, 1 to 2 mm smaller) than the width W2 of the outer periphery of the corresponding opening rings 611 and 615, the impedance of the first and second loop circuits will not be significantly affected. When the width W1 of the ground connection portions 614 and 618 is significantly smaller (for example, smaller than ⅔ of W2 or smaller than ½ of W2) than the width W2 of the outer periphery of the corresponding opening rings 611 and 615, the impedance of the first and second loop circuits will be significantly affected, leading to a problem of poor impedance matching of the patch radiating element 10. However, by providing the stubs 613 and 617 described above on the inner circumferences of the corresponding opening rings 611 and 615, the impedance of the first and second loop circuits can be adjusted. As a result, it is possible to easily improve the impedance matching of the patch radiating element 10 without changing the resonance frequencies of the opening rings 611 and 615.

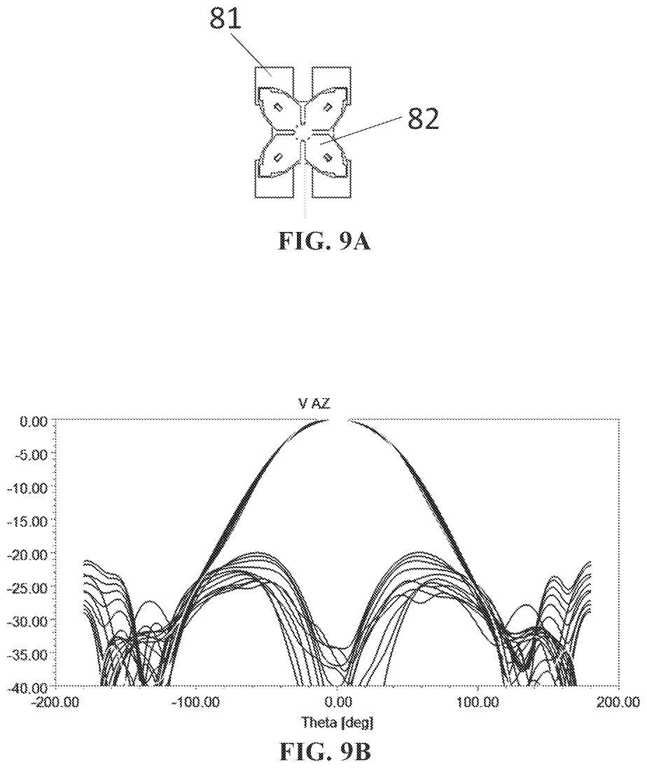

FIG. 9a is a top view of a multi-band antenna assembly according to some embodiments of the present disclosure. The multi-band antenna assembly includes a first array including one or more radiating elements 81 configured to transmit and receive RF signals in a high frequency band, and a second array including one or more radiating elements 82 configured to transmit and receive RF signals in a low frequency band. The radiating element 81 is the patch radiating element 10 according to any one embodiment of the present disclosure. In an embodiment, the radiating element 81 includes a feeder pillar extending forward from the reflector, and a patch radiator positioned at a specific position in front of the feeder pillar. The feeder pillar is configured as a PCB feeder pillar, and a grounded loop circuit is provided on a first main surface of the feeder pillar. The loop circuit has a gap. A feed circuit coupled to an RF signal input is provided on a second main surface of the feeder pillar. The feed circuit crosses the gap to excite the loop circuit, so that the loop circuit feeds the patch radiator in an electromagnetic coupling manner.

As described above, the length of the feeder pillar of the radiating element 81 implemented as a patch radiating element extending forward from the feed board is usually less than 0.2 λ1, for example, from 0.05 to 0.15 λ1, from 0.08 to 0.12 λ1, or may be about 0.1 λ1 (λ1 is the wavelength corresponding to the center frequency of a high frequency band in which the radiating element 81 works). This makes the current path in the radiating element 81 not equal to 0.5 λ1, that is, basically not exactly equal to 0.25 λ2 (where λ2 is the wavelength corresponding to the center frequency of a low frequency band in which the radiating element 82 works), and thus the radiating element 81 implemented as a patch radiating element will not generate ¼ wavelength resonance to the radiating element 82. Therefore, the multi-band antenna assembly according to some embodiments of the present disclosure can prevent the common mode resonance generated by the radiating element working in the high frequency band from affecting the radiation pattern of the radiating element working in the low frequency band.

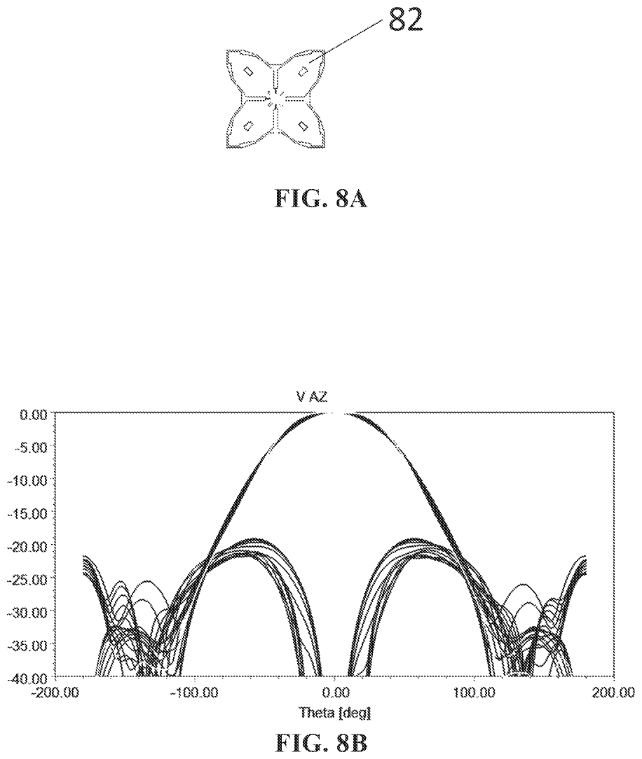

FIG. 9b is a radiation pattern of the low-band radiating element 82 in the antenna assembly shown in FIG. 9a in the azimuth plane. FIG. 8b is a radiation pattern of the low-band radiating element 82 in the antenna assembly shown in FIG. 8a in the azimuth plane, wherein the antenna assembly shown in FIG. 8a only includes the low-band radiating element 82 and does not include other high-band radiating elements. It can be seen that the radiation pattern in FIG. 9b is almost the same as the radiation pattern in FIG. 8b. That is, in the antenna assembly shown in FIG. 9a, the radiating element 81 working in the high frequency band does not have an effect of common mode resonance on the radiating element 82 working in the low frequency band.

Although exemplary embodiments of the present disclosure have been described, those skilled in the art should understand that many variations and modifications are possible in the exemplary embodiments without materially departing from the spirit and scope of the present disclosure. Therefore, all variations and modifications are included in the protection scope of the present disclosure defined by the claims.

1. A patch radiating element, comprising:
a feeder pillar; and
a patch radiator mounted on a forward portion of the feeder pillar, the patch radiator comprising:
a first patch portion that extends in a first direction; and
a second patch portion that extends from an outer end portion of the first patch portion in a second direction that is different from the first direction.

2. The patch radiating element according to claim 1, wherein the patch radiator is configured as a sheet metal radiator.

3. The patch radiating element according to claim 1, wherein the patch radiating element is configured as an air dielectric patch radiating element.

4. The patch radiating element according to claim 1, wherein the second patch portion and the first patch portion are integrally shaped.

5. The patch radiating element according to claim 1, wherein an angle of the first direction relative to the second direction is in a range of 80° to 100°.

6. The patch radiating element according to claim 1, wherein at least a part of the second patch portion is bent forwardly relative to the first patch portion.

7. The patch radiating element according to claim 1, wherein at least a part of the second patch portion is bent rearwardly relative to the first patch portion.

8. The patch radiating element according to claim 1, wherein the first patch portion is configured as a rectangular metal sheet.

9. (canceled)

10. The patch radiating element according to claim 8, wherein each side edge of the first patch portion is connected with a corresponding second patch portion, and wherein the second patch portions respectively extend from a corresponding side edge of the first patch portion in the second direction.

11. The patch radiating element according to claim 1, wherein a ratio of a sum of areas of the second patch portions to an area of the first patch portion is not greater than 0.5.

12. The patch radiating element according to claim 1, wherein the feeder pillar is configured to have an LC resonator to compensate at least partially for a change in an LC parameter caused by a change in a shape of the patch radiator.

13-18. (canceled)

19. An antenna, comprising:
a reflector, and
a plurality of arrays of patch radiating elements according claim 1 mounted on the reflector.

20. (canceled)

21. A patch radiating element, including:
a feeder pillar, which is configured as a PCB feeder pillar; and
a patch radiator, which is positioned at a specific position in front of the feeder pillar,
wherein a grounded first loop circuit is provided on a first main surface of the feeder pillar, the first loop circuit has a first gap, a first feed circuit coupled to a first RF signal input is provided on a second main surface of the feeder pillar, the first feed circuit crosses the first gap to excite the first loop circuit, thereby feeding the patch radiator, and
wherein the first loop circuit includes a first opening ring configured to have a rectangular inner circumference and a first stub positioned at a location that is at least a first corner of the first opening ring, and an opening of the first opening ring forms the first gap.

22. The patch radiating element according to claim 21, wherein the first opening ring includes adjacent first and second sides located at the first corner, and the first stub extends from the first side along the second side inside the first opening ring.

23. The patch radiating element according to claim 21, wherein the first gap is located at a front portion of the first opening ring.

24. The patch radiating element according to claim 21, wherein the first loop circuit further includes a ground connection portion extending rearward from an outer periphery of a rear end of the first opening ring, and the ground connection portion has a width smaller than the width of the outer periphery of the first opening ring, smaller than 2/3 of the width of the outer periphery of the first opening ring, or smaller than 1/2 of the width of the outer periphery of the first opening ring.

25. The patch radiating element according to claim 21, wherein the first loop circuit feeds the patch radiator in an electromagnetic coupling manner.

26. The patch radiating element according to claim 21, wherein:
a grounded second loop circuit is further provided on the first main surface of the feeder pillar, the second loop circuit has a second gap, the second loop circuit and the first loop circuit are substantially symmetrical about a first axis in a front-rear direction, and
a second feed circuit coupled to the first RF signal input is further provided on the second main surface of the feeder pillar, and the second feed circuit crosses the second gap to excite the second loop circuit, thereby feeding the patch radiator together with the first loop circuit.

27. The patch radiating element according to claim 26, wherein the feeder pillar is a first feeder pillar, the patch radiating element further includes a second feeder pillar,
wherein a third loop circuit with a third gap and a fourth loop circuit with a fourth gap are respectively provided on a first main surface of the second feeder pillar, the third loop circuit and the fourth loop circuit are substantially symmetrical about a second axis in the front-rear direction,
wherein a third feed circuit and a fourth feed circuit that are commonly coupled to a second RF signal input are provided on a second main surface of the second feeder pillar, the third feed circuit and the fourth feed circuit cross the third gap and the fourth gap respectively to excite the third loop circuit and the fourth loop circuit, thereby feeding the patch radiator, and
wherein the first feeder pillar is provided with a first mounting portion at the first axis, the second feeder pillar is provided with a second mounting portion at the second axis, the first feeder pillar and the second feeder pillar are mounted substantially perpendicular to each other via the first mounting portion and the second mounting portion, so that the first feeder pillar feeds a first RF signal to the patch radiator in a first polarization direction and the second feeder pillar feeds a second RF signal to the patch radiator in a second polarization direction.

28. (canceled)

29. The patch radiating element according to claim 21, wherein the patch radiator includes a first patch portion that extends in a first direction and a second patch portion that extends from an outer end portion of the first patch portion in a second direction, the second direction different from the first direction.

30-45. (canceled)
